(19) United States
(12) Patent Application Publication
(10) Pub. No.: US 2023/0153550 A1
(43) Pub. Date: May 18, 2023

(54) Machine Translation Method and Apparatus, Device and Storage Medium

(71) Applicant: Beijing Baidu Netcom Science Technology Co., Ltd., Beijing (CN)

(72) Inventors: Liwen ZHANG, Beijing (CN); Meng SUN, Beijing (CN); Zhi LI, Beijing (CN); Zhongjun HE, Beijing (CN)

(21) Appl. No.: 18/096,297

(22) Filed: Jan. 12, 2023

(30) Foreign Application Priority Data
Apr. 22, 2022 (CN) 202210431485.4

(51) Int. Cl. G06F 40/58; G06F 40/51

(52) U.S. Cl. CPC G06F 40/58; G06F 40/51

(57) ABSTRACT

A machine translation method can include: acquiring a to-be-translated source text; generating an intervention text corresponding to the to-be-translated source text by using intervention symbols, the intervention text including a term vocabulary part and an other text part; translating the intervention text to obtain a first translation result of the intervention text, where the first translation result includes a translation result of the other text part and the term vocabulary part; and generating a target translated text of the to-be-translated source text based on the first translation result and preset translated content of the term vocabulary part.

### CROSS-REFERENCE TO RELATED APPLICATIONS

The present application claims the priority of Chinese Patent Application No. 202210431485.4, titled “Machine Translation Method and Apparatus, Device, and Storage Medium”, filed on Apr. 22, 2022, the content of which is incorporated herein by reference in its entirety.

### TECHNICAL FIELD

The present disclosure relates to the field of artificial intelligence, and more particularly, to the field of deep learning, natural language processing, and the like, and more particularly, to a machine translation method and apparatus, device, and storage medium.

### BACKGROUND

Machine translation, also known as automatic translation, is a process of converting one natural language (source language) into another natural language (target language) using a computer. At present, with the development of artificial intelligence, natural language processing, and other technologies, the machine translation has been widely used in scenarios such as simultaneous interpretation and foreign language teaching. For example, in the scenario of the simultaneous interpretation, machine translation techniques may convert the speaker's language type to a different language type, thereby facilitating communication.

### SUMMARY

The present disclosure provides a machine translation method and apparatus, device, and storage medium.

According to a first aspect of the present disclosure, a machine translation method is provided. The method may include: acquiring a to-be-translated source text; generating an intervention text corresponding to the to-be-translated source text by using intervention symbols, where the intervention text includes a term vocabulary part and an other text part; translating the intervention text to obtain a first translation result of the intervention text, where the first translation result includes a translation result of the other text part and the term vocabulary part; and generating a target translated text of the to-be-translated source text based on the first translation result and a preset translated content of the term vocabulary part.

According to a second aspect of the present disclosure, a machine translation apparatus is provided. The apparatus may include: an acquisition module, configured to acquire a to-be-translated source text; a first generation module, configured to generate an intervention text corresponding to the to-be-translated source text by using intervention symbols, where the intervention text includes a term vocabulary part and an other text part; a translation module, configured to translate the intervention text to obtain a first translation result of the intervention text, where the first translation result includes a translation result of the other text part and the term vocabulary part; and a second generation module, configured to generate a target translated text of the to-be-translated source text based on the first translation result and a preset translated content of the term vocabulary part.

According to a third aspect of the present disclosure, an electronic device is provided. The electronic device includes at least one processor, and a memory communicatively connected to the at least one processor; where the memory stores instructions executable by the at least one processor, and the instructions, when executed by the at least one processor, cause the at least one processor to perform the method as described in any implementation according to the first aspect.

According to a fourth aspect of the present disclosure, a non-transitory computer readable storage medium storing computer instructions is provided. The computer instructions are used to cause the computer to perform the method as described in any implementation according to the first aspect.

It should be understood that contents described in this section are neither intended to identify key or important features of embodiments of the present disclosure, nor intended to limit the scope of the present disclosure. Other features of the present disclosure will become readily understood in conjunction with the following description.

### BRIEF DESCRIPTION OF THE DRAWINGS

The accompanying drawings are used for better understanding of the present solution, and do not constitute a limitation to the present disclosure. In which:

FIG. 1 is an exemplary system architecture in which embodiments of the present disclosure may be applied;

FIG. 2 is a flowchart of a machine translation method according to an embodiment of the present disclosure;

FIG. 3 is a schematic diagram of an application scenario of a machine translation method according to an embodiment of the present disclosure;

FIG. 4 is a flowchart of a machine translation method according to another embodiment of the present disclosure;

FIG. 5 is a flowchart of yet a machine translation method according to another embodiment of the present disclosure;

FIG. 6 is a schematic structural diagram of a machine translation apparatus according to an embodiment of the present disclosure;

FIG. 7 is a block diagram of an electronic device used to implement a machine translation method according to an embodiment of the present disclosure.

### DETAILED DESCRIPTION OF EMBODIMENTS

Example embodiments of the present disclosure are described below with reference to the accompanying drawings, where various details of the embodiments of the present disclosure are included to facilitate understanding, and should be considered merely as examples. Therefore, those of ordinary skills in the art should realize that various changes and modifications can be made to the embodiments described here without departing from the scope and spirit of the present disclosure. Similarly, for clearness and conciseness, descriptions of well-known functions and structures are omitted in the following description.

It is noted that the embodiments in the present disclosure and the features in the embodiments may be combined with each other without conflict. The present disclosure will now be described in detail with reference to the accompanying drawings and embodiments.

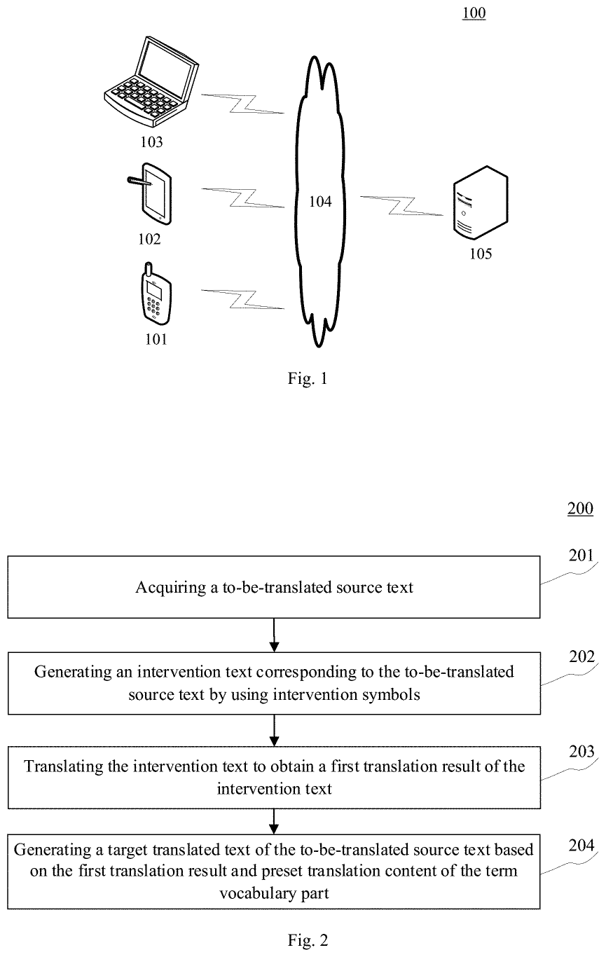

FIG. 1 illustrates an exemplary system architecture 100 to which embodiments of a machine translation method or a machine translation apparatus of the present disclosure may be applied.

As shown in FIG. 1, the system architecture 100 may include terminal devices 101, 102, and 103, a network 104, and a server 105. The network 104 serves as a medium for providing a communication link between the terminal devices 101, 102, and 103 and the server 105. The network 104 may include various types of connections, such as wired communication link, wireless communication link, or fiber optic cables, and the like.

The user may interact with the server 105 through the network 104 using the terminal devices 101, 102, 103 to receive or transmit information or the like. Various client applications may be installed on the terminal devices 101, 102, 103.

The terminal devices 101, 102, 103 may be hardware or software. When the terminal devices 101, 102, 103 are hardware, they may be various electronic devices, including but not limited to a mobile phone, a tablet computer, a laptop and a desktop computer, and the like. When the terminal devices 101, 102, and 103 are software, they may be installed in the electronic devices listed above. It may be implemented as a plurality of software or software modules or as a single software or software module. It is not specifically limited herein.

The server 105 may provide various services. For example, the server 105 may analyze and process the to-be-translated source text acquired from the terminal devices 101, 102, 103, and generate a processing result (e.g., target translated text).

It should be noted that the server 105 may be hardware or software. When the server 105 is hardware, it may be implemented as a distributed server cluster of multiple servers, or it may be implemented as a single server. When the server 105 is software, it may be implemented as a plurality of software or software modules (e.g., for providing distributed services), or it may be implemented as a single software or software module. It is not specifically limited herein.

It should be noted that the machine translation method provided in the embodiments of the present disclosure is generally performed by the server 105, and accordingly, the machine translation apparatus is generally provided in the server 105.

It should be understood that the number of the terminal devices, the networks and the servers in FIG. 1 is merely illustrative. There may be any number of the terminal devices, the networks and the servers as desired for implementation.

Further referring to FIG. 2, FIG. 2 illustrates a flow 200 of a machine translation method according to an embodiment of the present disclosure. The machine translation method includes the steps 201-204.

Step 201, acquiring a to-be-translated source text.

In the present embodiment, an executing body of the machine translation method (for example, the server 105 shown in FIG. 1) may acquire the to-be-translated source text, where the to-be-translated source text is a to-be-translated text. In the machine translation, a source language refers to the language being translated, and a source text (i.e., the source language text) refers to a text using the language being translated. In the present embodiment, the source text is translated into a target text, the target text referring to a translated text using the target language. In practical application, the source text is usually an English text, and the target text is usually a Chinese text. Of course, the source text and the target text may also be text in other languages, and may be set according to actual requirements. This is not specifically limited in this embodiment.

Step 202, generating an intervention text corresponding to the to-be-translated source text by using intervention symbols.

In the present embodiment, the executing body may generate the intervention text corresponding to the to-be-translated source text by using the intervention symbols, the intervention symbols are predefined symbols, and the intervention text includes a term vocabulary part and an other text part. That is, in the present embodiment, the executing body may divide the to-be-translated source text into the term vocabulary part and the other text part, and mark the term vocabulary part with the intervention symbols, thereby obtaining the intervention text corresponding to the to-be-translated source text. For example, the executing body may first identify whether the to-be-translated source text contains a predefined term vocabulary, and if so, wrap the term vocabulary with the intervention symbols to obtain the intervention text. It should be noted that the other text in the to-be-translated source text excluding the term vocabulary part is referred to as the other text part.

It should be noted that since proper nouns and some new words are migrated and appeared over time, it is impossible to make the model to learn the translation of these words by means of data enhancement or the like. Therefore, in the present embodiment, a plurality of term vocabularies are defined in advance. The term vocabularies are generally the proper nouns and the new words, and the term vocabularies may be defined according to actual scene requirements, for example, names of protagonists in novels, and the like. By predefining the term vocabularies and the corresponding translations, consistency of the translation results of the term vocabularies may be ensured.

Step 203, translating the intervention text to obtain a first translation result of the intervention text.

In the present embodiment, the executing body may translate the intervention text to obtain the first translation result of the intervention text, the first translation result includes a translation result of the other text part and the term vocabulary part. Since the intervention text contains the term vocabulary part wrapped by the intervention symbols, when translating the intervention text, the executing body only translates the other text part in the intervention text, and does not translate the term vocabulary part wrapped by the intervention symbols, thereby obtaining the translation result containing the other text part and the first translation result of the term vocabulary part wrapped by the intervention symbols.

Step 204, generating a target translated text of the to-be-translated source text based on the first translation result and preset translated content of the term vocabulary part.

In the present embodiment, the executing body may generate the target translated text corresponding to the to-be-translated source text based on the first translation result and the preset translated content of the predefined term vocabulary part. In the present embodiment, since the other text part in the intervention text is translated and the term vocabulary part is not translated when translating the intervention text, the first translation result includes the translation result of the other text part and the term vocabulary part wrapped by the intervention symbols. Then, the executing body may acquire the preset translated content of the predefined term vocabulary part, and replace the term vocabulary part in the first translation result with the preset translated content, thereby obtaining the final translated text, that is, the target translation text, which contains both the translation result of the term vocabulary part and the translation result of the other text part.

In the machine translation method provided in the embodiment of the present disclosure, a to-be-translated source text is acquired first; then, an intervention text corresponding to the to-be-translated source text is generated by using intervention symbols, where the intervention text includes the term vocabulary part and the other text part; thereafter, the intervention text is translated to obtain a first translation result of the intervention text, where the first translation result includes the translation result of the other text part and the term vocabulary part; finally, a target translated text of the to-be-translated source text is generated based on the first translation result and a preset translated content of the term vocabulary part. In the machine translation method of the present embodiment, the term vocabulary is wrapped by the intervention symbols, only the other text part is translated in the translation process of the intervention text, and finally the final target translated text is acquired based on the preset translated content of the term vocabulary part, thereby ensuring consistency of the translation result of the term vocabularies and improving the translation quality.

In the technical solution of the present disclosure, the processes of collecting, storing, using, processing, transmitting, providing, and disclosing the user's personal information all comply with the provisions of the relevant laws and regulations, and do not violate the public order and good customs.

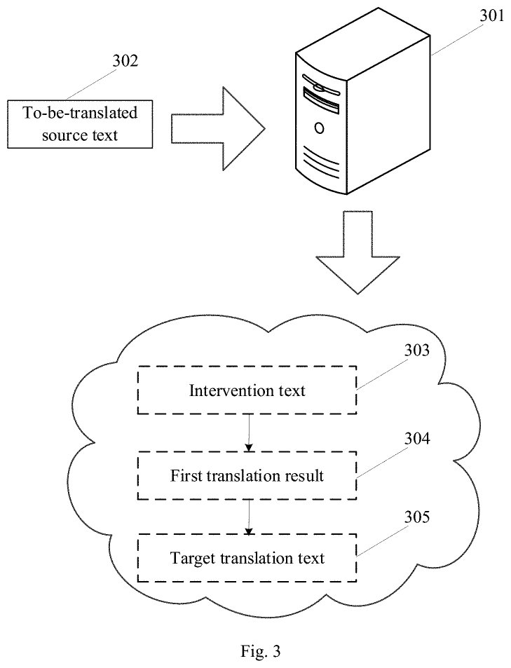

Further referring to FIG. 3, the schematic diagram of an application scenario of the machine translation method according to the present disclosure is shown. In this application scenario, the executing body 301 first acquires the to-be-translated source text 302. Then, the executing body 301 marks the term vocabulary in the to-be-translated source text 302 with the intervention symbols, thereby obtaining the intervention text 303 including the term vocabulary part and other text part. Thereafter, the executing body 301 translates the intervention text 303 to obtain the translation result including the other text part and the first translation result 304 of the term vocabulary part. Finally, the executing body acquires the preset translated content of the term vocabulary part and generates the target translated text 305 corresponding to the to-be-translated source text based on the first translation result 304 and the preset translated content of the term vocabulary part.

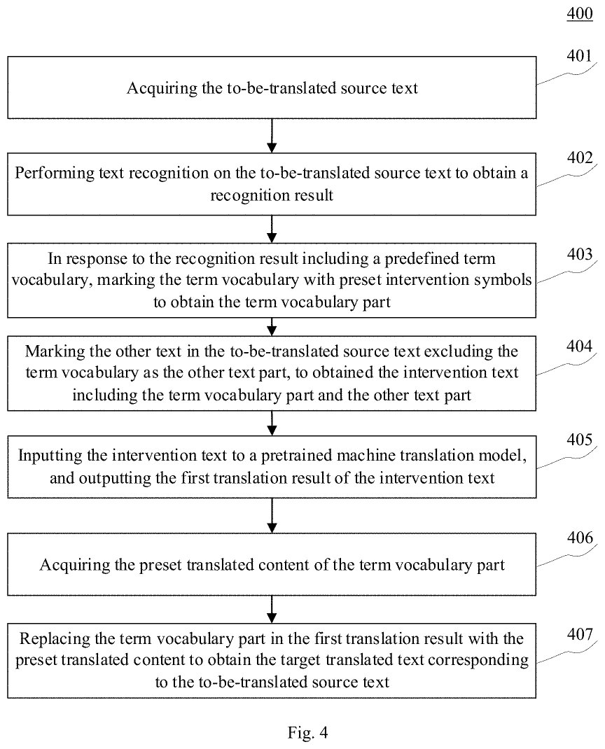

Further referring to FIG. 4, FIG. 4 illustrates a flow diagram 400 of the machine translation method according to another embodiment of the present disclosure. The machine translation method includes the steps 401-407.

Step 401, acquiring the to-be-translated source text.

In the present embodiment, the executing body of the machine translation method (for example, the server 105 shown in FIG. 1) may first acquire the to-be-translated source text. The step 401 is substantially consistent with the step 201 of the foregoing embodiment. For a specific implementation, reference may be made to the foregoing description of the step 201, and details are not repeated herein.

Step 402, performing text recognition on the to-be-translated source text to obtain a recognition result.

In the present embodiment, the executing body may perform text recognition on the to-be-translated source text, thereby obtaining the recognition result. The text recognition method may be implemented using the existing art, and details are not described herein.

Step 403, in response to the recognition result including a predefined term vocabulary, marking the term vocabulary with preset intervention symbols to obtain the term vocabulary part.

In the present embodiment, a plurality of term vocabularies may be predefined, and the executing body may determine whether the recognition result includes a predefined term vocabulary, and when the recognition result includes the term vocabulary, mark the term vocabulary with the preset intervention symbols, thereby obtaining the term vocabulary part.

In some alternative embodiments of the present embodiment, the step 403 includes: marking a first intervention symbol at a start position of the term vocabulary and marking a second intervention symbol at an end position of the term vocabulary in response to the recognition result including predefined term vocabulary, to obtain the term vocabulary part wrapped by the first intervention symbol and the second intervention symbol.

In the present implementation, in the case that the executing body determines that the recognition result contains a predefined term vocabulary, the first intervention symbol is marked at the start position of the term vocabulary and the second intervention symbol is marked at the end position of the term vocabulary, thereby obtaining the term vocabulary part wrapped by the first intervention symbol and the second intervention symbol, the first intervention symbol may be expressed as <B> and the second intervention symbol may be expressed as <E>.

For example, assuming that a first character of the to-be-translated source text is the term vocabulary “CNN”, in the case that the executing body determines that “CNN” is a predefined term vocabulary, the executing body may mark the first intervention symbol at the start position of “CNN”, that is, mark the first intervention symbol <B> before a alphabet “C” and mark the second intervention symbol <E> after a alphabet “N”, such that the obtained term vocabulary part wrapped by the first intervention symbol and the second intervention symbol may represent as <B>CNN<E>. At the same time, alternatively, since the term vocabulary is the first word of the to-be-translated source text, then an index value of the term vocabulary in the to-be-translated source text is 0, so that the term vocabulary is further more accurately marked on the basis of the index value of the term vocabulary, that is, the first intervention symbol and the second intervention symbol may be expressed as <B0> and <E0>, that is, the last obtained term vocabulary part wrapped by the first intervention symbol and the second intervention symbol may be expressed as <B0>CNN<E0>.

Step 404, marking the other text in the to-be-translated source text excluding the term vocabulary as the other text part, to obtain the intervention text including the term vocabulary part and the other text part.

In the present embodiment, after marking the term vocabulary part in the to-be-translated source text, the executing body may mark the other text in the to-be-translated source text excluding the term vocabulary as the other text part, to obtain the intervention text, that is, the intervention text includes the term vocabulary part and the other text part.

By means of the above steps, it is achieved that the term vocabulary is wrapped by intervention symbols, thereby obtaining the intervention text.

Step 405, inputting the intervention text to a pretrained machine translation model, and outputting the first translation result of the intervention text.

In the present embodiment, the above-described executing body may input the intervention text to the pretrained machine translation model, and output the first translation result to obtain the intervention text. The machine translation model includes an embedding layer, and an extended area of the embedding layer storing the first intervention symbol and the second intervention symbol. The machine translation model may be trained on the basis of a Neural Machine Translation (NMT) model, which may be an existing neural machine translation model. In the present embodiment, the existing neural machine translation model is extended, and the first intervention symbol and the second intervention symbol are stored in the extended area of the embedding layer of the machine translation model, so that the machine translation model in the present embodiment may be obtained. When the intervention text is translated using the machine translation model, only other text part is translated (i.e., the part not marked with the intervening symbols is translated), while the part wrapped by the intervening symbols is not translated. By inputting the intervention text to the obtained machine translation model, the executing body may output the first translation result of the intervention text.

The machine translation model in this embodiment has an input and a model structure consistent with a general model, so that the machine translation model may be extended on-line without requiring retraining and deploying. In addition, when a new intervention vocabulary is added, the model does not need to be retrained, thereby saving time cost.

Step 406, acquiring the preset translated content of the term vocabulary part.

In the present embodiment, the executing body may acquire the preset translated content of the term vocabulary in the to-be-translated source text from a predefined term vocabulary and a translation set corresponding to the term vocabulary.

Step 407, replacing the term vocabulary part in the first translation result with the preset translated content to obtain the target translated text of the to-be-translated source text.

In the present embodiment, the executing body may replace the term vocabulary part in the first translation result with the acquired preset translated content, to obtain the target translated text of the to-be-translated source text, thereby ensuring the consistency of the translation result of the term vocabulary.

As can be seen from FIG. 4, compared with the corresponding embodiment of FIG. 2, the machine translation method of the present embodiment highlights the steps of generating the intervention text and generating the target translated text, thereby wrapping the term vocabulary with the intervention symbols to obtain the corresponding intervention text. In the process of translating the intervention text, the term vocabulary wrapped by the intervention symbols is not translated, and finally the term vocabulary part in the translation result of the intervention text is replaced with the preset translated content of the term vocabulary, thereby ensuring the consistency of the translation result of the term vocabulary and improving the translation efficiency and quality.

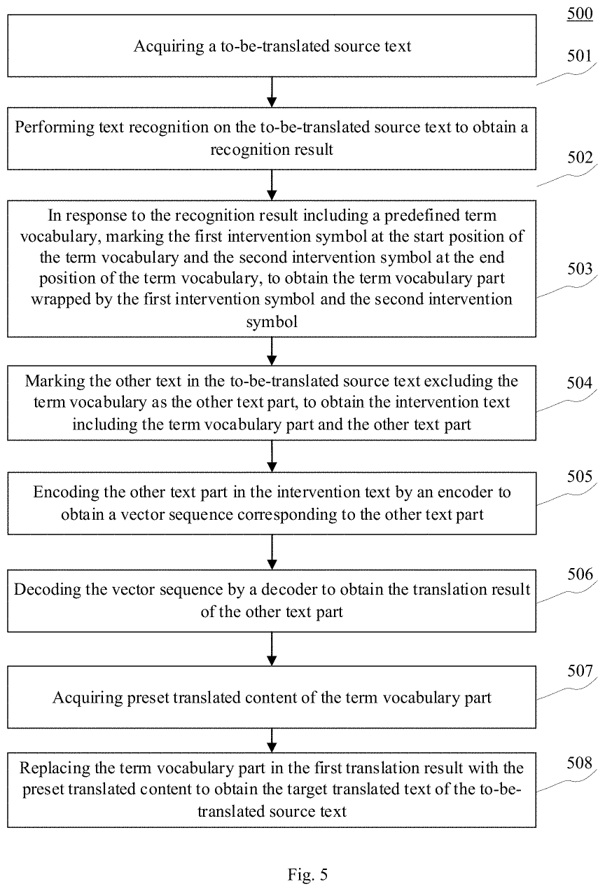

Further referring to FIG. 5, FIG. 5 illustrates a flow 500 of the machine translation method according to yet another embodiment of the present disclosure is shown. The machine translation method includes the steps 501-505.

Step 501, acquiring the to-be-translated source text.

Step 502, performing text recognition on the to-be-translated source text to obtain a recognition result.

The steps 501-502 are substantially consistent with the steps 401-402 of the foregoing embodiment. For a specific implementation, reference may be made to the foregoing description of the steps 401-402, and details are not described herein.

Step 503, in response to the recognition result including a predefined term vocabulary, marking the first intervention symbol at the start position of the term vocabulary and the second intervention symbol at the end position of the term vocabulary, to obtain the term vocabulary part wrapped by the first intervention symbol and the second intervention symbol.

In the present embodiment, the executing body of the machine translation method (for example, the server 105 shown in FIG. 1) may mark the first intervention symbol at the start position of the term vocabulary and the second intervention symbol at the end position of the term vocabulary when it is determined that the recognition result includes a predefined term vocabulary, thereby obtaining the term vocabulary part wrapped by the first intervention symbol and the second intervention symbol.

Step 504, marking the other text in the to-be-translated source text excluding the term vocabulary as the other text part, to obtain the intervention text including the term vocabulary part and the other text part.

The step 504 is substantially identical to the step 404 of the foregoing embodiment. For a specific implementation, reference may be made to the foregoing description of the step 404, and details are not described herein.

Step 505, encoding the other text part in the intervention text by an encoder to obtain a vector sequence corresponding to the other text part.

In the present embodiment, the machine translation model includes an encoder and a decoder, and the executing body may encode the other text part in the intervention text by the encoder of the machine translation model, thereby obtaining the vector sequence corresponding to the other text part.

In some alternative embodiments of the present embodiment, the step 505 includes: performing word segmentation on the other text part in the intervention text by an encoder to obtain a word segmentation result; generating feature vectors corresponding to respective words in the word segmentation result; generating the vector sequence corresponding to the other text part based on the feature vectors corresponding to the words in the word segmentation result.

In the present implementation, the executing body may use the encoder in the machine translation model to the perform word segmentation on the other text part in the intervention text to obtain a corresponding word segmentation result; then respectively generate feature vectors of words in the word segmentation result; and generate a vector sequence of the other text part based on the feature vectors of the words in the word segmentation result. Thus, the process of encoding the other text part is completed by the encoder.

Step 506, decoding the vector sequence by a decoder to obtain the translation result of the other text part.

In the present embodiment, the executing body may decode the vector sequence generated in the step 505 by the decoder, thereby obtaining the translation result of the other text part.

Step 507, acquiring preset translated content of the term vocabulary part.

Step 508, replacing the term vocabulary part in the first translation result with the preset translated content to obtain the target translated text of the to-be-translated source text.

The steps 507-508 are substantially consistent with the steps 406-407 of the foregoing embodiment. For a specific implementation, reference may be made to the foregoing description of steps 406-407, and details are not described herein.

As can be seen from FIG. 5, compared with the corresponding embodiment of FIG. 4, the machine translation method in this embodiment highlights the process of encoding the intervention text with the encoder and decoding the intervention text with the decoder to obtain the translation result, thereby improving the accuracy of the obtained translation result.

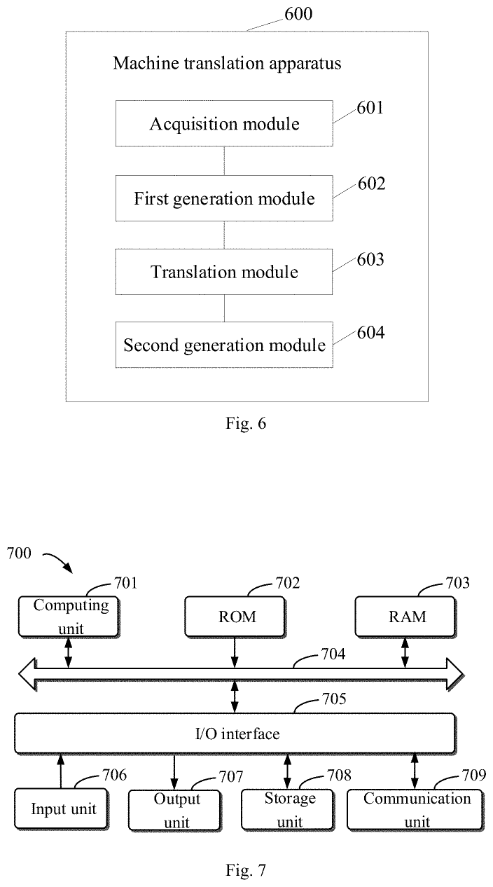

Further referring to FIG. 6, as an implementation of the method shown in each of the above figures, an embodiment of the present disclosure provides a machine translation apparatus, which corresponds to the method embodiment shown in FIG. 2 and is particularly applicable to various electronic devices.

As shown in FIG. 6, the machine translation apparatus 600 of the present embodiment includes: an acquisition module 601, a first generation module 602, a translation module 603, and a second generation module 604. The acquisition module 601 is configured to acquire a to-be-translated source text. The first generation module 602 is configured to generate an intervention text corresponding to the to-be-translated source text by using intervention symbols, where the intervention text includes a term vocabulary part and an other text part. The translation module 603 is configured to translate the intervention text to obtain a first translation result of the intervention text, where the first translation result includes a translation result of the other text part and the term vocabulary part. The second generation module 604 is configured to generate a target translated text of the to-be-translated source text based on the first translation result and preset translated content of the term vocabulary part.

In the present embodiment, the specific processing and the technical effects of the acquisition module 601, the first generation module 602, the translation module 603, and the second generation module 604 may be described with reference to the related description of the steps 201-204 in the corresponding embodiment in FIG. 2, and details are not described herein again.

In some alternative implementations of the present embodiment, the first generation module includes: an identification submodule, configured to perform text recognition on the to-be-translated source text to obtain a recognition result; a first marking submodule, configured to, in response to the recognition result including a predefined term vocabulary, mark the term vocabulary with preset intervention symbols to obtain the term vocabulary part; and a second marking sub-module, configured to mark other text in the to-be-translated source text excluding the term vocabulary as an other text part.

In some alternative implementations of the present embodiment, the first marking submodule is further configured to mark a first intervention symbol at a start position of the term vocabulary and a second intervention symbol at an end position of the term vocabulary, to obtain the term vocabulary part wrapped by the first intervention symbol and the second intervention symbol.

In some alternative implementations of the present embodiment, the translation module includes a translation submodule, configured to input the intervention text to a pretrained machine translation model, and output the first translation result of the intervention text, where the machine translation model includes an embedding layer, an extended area of the embedding layer storing the first intervention symbol and the second intervention symbol.

In some alternative implementations of the present embodiment, the machine translation model further includes an encoder and a decoder, and the translation submodule includes: an encoding unit, configured to encode the other text part in the intervention text by the encoder to obtain a vector sequence corresponding to the other text part; and a decoding unit, configured to decode the vector sequence by the decoder to obtain the translation result of the other text part.

In some alternative implementations of the present embodiment, the encoding unit includes: a segmentation subunit, configured to perform word segmentation on the other text part in the intervention text by an encoder to obtain a word segmentation result; a first generation subunit, configured to generate feature vectors corresponding to the words in the word segmentation result in the segmentation result; and a second generation subunit, configured to generate the vector sequence corresponding to the other text part based on the feature vectors corresponding to the words in the word segmentation result.

In some alternative implementations of the present embodiment, the second generation module includes: an acquisition submodule, configured to acquire preset translated content of the term vocabulary part; and a replacement submodule, configured to replace the term vocabulary part in the first translation result with the preset translated content to obtain the target translated text of the to-be-translated source text.

According to an embodiment of the present disclosure, the present disclosure further provides an electronic device, a readable storage medium, and a computer program product.

FIG. 7 illustrates a schematic block diagram of an example electronic device 700 that may be used to implement embodiments of the present disclosure. The electronic device is intended to represent various forms of digital computers, such as laptop computers, desktop computers, worktables, personal digital assistants, servers, blade servers, mainframe computers, and other suitable computers. The electronic device may also represent various forms of mobile devices, such as personal digital processing, cellular telephones, smart phones, wearable devices, and other similar computing devices. The components shown herein, their connections and relationships, and their functions are by way of example only and are not intended to limit the implementation of the disclosure described and/or claimed herein.

As shown in FIG. 7, The electronic device 700 includes a computing unit 701, which may perform various appropriate actions and processes according to a computer program stored in a read-only memory (ROM) 702 or a computer program loaded into a random access memory (RAM) 703 from a storage unit 708. In RAM 703, various programs and data required for operation of the device 700 may also be stored. The computing unit 701, ROM 702 and RAM 703 are connected to each other via a bus 704. An input/output (I/O) interface 705 is also connected to a bus 704.

A plurality of components in the device 700 are connected to the I/O interface 705, including: an input unit 706, such as a keyboard, a mouse, and the like; an output unit 707, such as, various types of displays, speakers, and the like; a storage unit 708, such as a magnetic disk, an optical disk, or the like; and a communication unit 709, such as a network card, a modem, or a wireless communication transceiver. The communication unit 709 allows the device 700 to exchange information/data with other devices over a computer network such as the Internet and/or various telecommunications networks.

The computing unit 701 may be various general-purpose and/or special-purpose processing components having processing and computing capabilities. Some examples of computing units 701 include, but are not limited to, central processing units (CPUs), graphics processing units (GPUs), various specialized artificial intelligence (AI) computing chips, various computing units that run machine learning model algorithms, digital signal processors (DSPs), and any suitable processors, controllers, microcontrollers, and the like. The computing unit 701 performs various methods and processes described above, such as a machine translation method. For example, in some embodiments, the machine translation method may be implemented as a computer software program tangibly embodied in a machine-readable medium, such as a storage unit 708. In some embodiments, some or all of the computer program may be loaded and/or installed on the device 700 via the ROM 702 and/or the communication unit 709. When the computer program is loaded into the RAM 703 and executed by the computing unit 701, one or more steps of the machine translation method described above may be performed. Alternatively, in other embodiments, the computing unit 701 may be configured to perform the machine translation method by any other suitable means (e.g., by means of firmware).

Various embodiments of the systems and technologies described above in this paper can be implemented in digital electronic circuit systems, integrated circuit systems, field programmable gate arrays (FPGAs), application specific integrated circuits (ASIC), application specific standard products (ASSP), system on chip (SOC), load programmable logic devices (CPLD), computer hardware, firmware, software, and/or combinations thereof. These various embodiments may include: being implemented in one or more computer programs, the one or more computer programs can be executed and/or interpreted on a programmable system including at least one programmable processor, which can be a special-purpose or general-purpose programmable processor, and can receive data and instructions from the storage system, at least one input device, and at least one output device, and transmitting data and instructions to the storage system, the at least one input device, and the at least one output device.

The program code for implementing the methods of the present disclosure may be written in any combination of one or more programming languages. These program codes can be provided to the processor or controller of general-purpose computer, special-purpose computer or other programmable data processing device, so that when the program code is executed by the processor or controller, the functions/operations specified in the flow chart and/or block diagram are implemented. The program code can be completely executed on the machine, partially executed on the machine, partially executed on the machine and partially executed on the remote machine as a separate software package, or completely executed on the remote machine or server.

In the context of the present disclosure, a machine-readable medium may be a tangible medium that may contain or store a program for use by or in combination with an instruction execution system, apparatus, or device. The machine-readable medium can be a machine-readable signal medium or a machine-readable storage medium. Machine readable media may include, but are not limited to, electronic, magnetic, optical, electromagnetic, infrared, or semiconductor systems, apparatuses, or devices, or any suitable combination of the foregoing. More specific examples of machine-readable storage media may include one or more wire based electrical connections, portable computer disks, hard disks, random access memory (RAM), read only memory (ROM), erasable programmable read only memory (EPROM or flash memory), optical fibers, compact disk read only memory (CD-ROM), optical storage devices, magnetic storage devices, or any suitable combination of the above.

In order to provide interaction with users, the systems and techniques described herein can be implemented on a computer with: a display device for displaying information to users (for example, a CRT (cathode ray tube) or LCD (liquid crystal display) monitor); and a keyboard and a pointing device (e.g., a mouse or a trackball) through which the user can provide input to the computer. Other kinds of devices can also be used to provide interaction with users. For example, the feedback provided to the user may be any form of sensor feedback (e.g., visual feedback, auditory feedback, or tactile feedback); and the input from the user can be received in any form (including acoustic input, voice input or tactile input).

The systems and techniques described herein may be implemented in a computing system including background components (e.g., as a data server), or a computing system including middleware components (e.g., an application server) or a computing system including a front-end component (e.g., a user computer with a graphical user interface or a web browser through which a user can interact with embodiments of the systems and techniques described herein), or a computing system including any combination of the back-end component, the middleware component, the front-end component. The components of the system can be interconnected by digital data communication (e.g., communication network) in any form or medium. Examples of communication networks include local area networks (LANs), wide area networks (WANs), and the Internet.

A computer system may include a client and a server. The client and the server are generally far away from each other and usually interact through communication networks. The relationship between the client and the server is generated by computer programs running on the corresponding computers and having a client server relationship with each other. The server can be a cloud server, a distributed system server, or a blockchain server.

It should be understood that various forms of processes shown above can be used to reorder, add or delete steps. For example, the steps recorded in the present disclosure can be performed in parallel, in sequence, or in different orders, as long as the desired results of the technical solution of the present disclosure can be achieved, which is not limited herein.

The above specific embodiments do not constitute restrictions on the scope of the present disclosure. Those skilled in the art should understand that various modifications, combinations, sub combinations and substitutions can be made according to design requirements and other factors. Any modification, equivalent replacement and improvement made within the spirit and principles of this disclosure shall be included in the scope of protection of this disclosure.

What is claimed is:

1. A machine translation method, comprising:
acquiring a to-be-translated source text;
generating an intervention text corresponding to the to-be-translated source text by using intervention symbols, wherein the intervention text comprises a term vocabulary part and an other text part;
translating the intervention text to obtain a first translation result of the intervention text, wherein the first translation result comprises a translation result of the other text part and the term vocabulary part; and
generating a target translated text of the to-be-translated source text based on the first translation result and preset translated content of the term vocabulary part.

2. The method according to claim 1, wherein generating the intervention text corresponding to the to-be-translated source text by using the intervention symbols, comprises:
performing text recognition on the to-be-translated source text to obtain a recognition result;
in response to the recognition result comprising a predefined term vocabulary, marking the term vocabulary with preset intervention symbols to obtain the term vocabulary part; and
marking other text in the to-be-translated source text excluding the term vocabulary as the other text part.

3. The method according to claim 2, wherein marking the term vocabulary with the preset intervention symbols to obtain the term vocabulary part, comprises:
marking a first intervention symbol at a start position of the term vocabulary and a second intervention symbol at an end position of the term vocabulary, to obtain the term vocabulary part wrapped by the first intervention symbol and the second intervention symbol.

4. The method according to claim 3, wherein translating the intervention text to obtain the first translation result of the intervention text, comprises:
inputting the intervention text to a pretrained machine translation model, and outputting the first translation result of the intervention text, wherein the machine translation model comprises an embedding layer, an extended area of the embedding layer storing the first intervention symbol and the second intervention symbol.

5. The method according to claim 4, wherein the machine translation model further comprises an encoder and a decoder; and
inputting the intervention text to the pretrained machine translation model, and outputting the first translation result of the intervention text, comprises:
encoding the other text part in the intervention text by the encoder to obtain a vector sequence corresponding to the other text part; and
decoding the vector sequence by the decoder to obtain the translation result of the other text part.

6. The method according to claim 5, wherein encoding the other text part in the intervention text by the encoder to obtain the vector sequence corresponding to the other text part, comprises:
performing word segmentation on the other text part in the intervention text by the encoder to obtain a word segmentation result;
generating feature vectors corresponding to words in the word segmentation result; and
generating the vector sequence corresponding to the other text part based on the feature vectors corresponding to the words in the word segmentation result.

7. The method according to claim 1, wherein generating the target translated text of the to-be-translated source text based on the first translation result and the preset translated content of the term vocabulary part, comprises:
acquiring the preset translated content of the term vocabulary part; and
replacing the term vocabulary part in the first translation result with the preset translated content to obtain the target translated text of the to-be-translated source text.

8. An electronic device, comprising:
at least one processor; and
a memory that stores instructions executable by the at least one processor, the instructions, when executed by the at least one processor, cause the at least one processor to perform operations, the operations comprising:
acquiring a to-be-translated source text;
generating an intervention text corresponding to the to-be-translated source text by using intervention symbols, wherein the intervention text comprises a term vocabulary part and an other text part;
translating the intervention text to obtain a first translation result of the intervention text, wherein the first translation result comprises a translation result of the other text part and the term vocabulary part; and
generating a target translated text of the to-be-translated source text based on the first translation result and preset translated content of the term vocabulary part.

9. The electronic device according to claim 8, wherein generating the intervention text corresponding to the to-be-translated source text by using the intervention symbols, comprises:
performing text recognition on the to-be-translated source text to obtain a recognition result;
in response to the recognition result comprising a predefined term vocabulary, marking the term vocabulary with preset intervention symbols to obtain the term vocabulary part; and
marking other text in the to-be-translated source text excluding the term vocabulary as the other text part.

10. The electronic device according to claim 9, wherein marking the term vocabulary with the preset intervention symbols to obtain the term vocabulary part, comprises:
marking a first intervention symbol at a start position of the term vocabulary and a second intervention symbol at an end position of the term vocabulary, to obtain the term vocabulary part wrapped by the first intervention symbol and the second intervention symbol.

11. The electronic device according to claim 10, wherein translating the intervention text to obtain the first translation result of the intervention text, comprises:
inputting the intervention text to a pretrained machine translation model, and outputting the first translation result of the intervention text, wherein the machine translation model comprises an embedding layer, an extended area of the embedding layer storing the first intervention symbol and the second intervention symbol.

12. The electronic device according to claim 11, wherein the machine translation model further comprises an encoder and a decoder; and
inputting the intervention text to the pretrained machine translation model, and outputting the first translation result of the intervention text, comprises:
encoding the other text part in the intervention text by the encoder to obtain a vector sequence corresponding to the other text part; and
decoding the vector sequence by the decoder to obtain the translation result of the other text part.

13. The electronic device according to claim 12, wherein encoding the other text part in the intervention text by the encoder to obtain the vector sequence corresponding to the other text part, comprises:
performing word segmentation on the other text part in the intervention text by the encoder to obtain a word segmentation result;
generating feature vectors corresponding to words in the word segmentation result; and
generating the vector sequence corresponding to the other text part based on the feature vectors corresponding to the words in the word segmentation result.

14. The electronic device according to claim 8, wherein generating the target translated text of the to-be-translated source text based on the first translation result and the preset translated content of the term vocabulary part, comprises:
acquiring the preset translated content of the term vocabulary part; and
replacing the term vocabulary part in the first translation result with the preset translated content to obtain the target translated text of the to-be-translated source text.

15. A non-transitory computer readable storage medium storing computer instructions, wherein, the computer instructions, when executed by at least one processor, cause the at least one processor to perform operations, the operations comprising:
acquiring a to-be-translated source text;
generating an intervention text corresponding to the to-be-translated source text by using intervention symbols, wherein the intervention text comprises a term vocabulary part and an other text part;
translating the intervention text to obtain a first translation result of the intervention text, wherein the first translation result comprises a translation result of the other text part and the term vocabulary part; and
generating a target translated text of the to-be-translated source text based on the first translation result and preset translated content of the term vocabulary part.

16. The non-transitory computer readable storage medium according to claim 15, wherein generating the intervention text corresponding to the to-be-translated source text by using the intervention symbols, comprises:
performing text recognition on the to-be-translated source text to obtain a recognition result;
in response to the recognition result comprising a predefined term vocabulary, marking the term vocabulary with preset intervention symbols to obtain the term vocabulary part; and
marking other text in the to-be-translated source text excluding the term vocabulary as the other text part.

17. The non-transitory computer readable storage medium according to claim 16, wherein marking the term vocabulary with the preset intervention symbols to obtain the term vocabulary part, comprises:
marking a first intervention symbol at a start position of the term vocabulary and a second intervention symbol at an end position of the term vocabulary, to obtain the term vocabulary part wrapped by the first intervention symbol and the second intervention symbol.

18. The non-transitory computer readable storage medium according to claim 17, wherein translating the intervention text to obtain the first translation result of the intervention text, comprises:
inputting the intervention text to a pretrained machine translation model, and outputting the first translation result of the intervention text, wherein the machine translation model comprises an embedding layer, an extended area of the embedding layer storing the first intervention symbol and the second intervention symbol.

19. The non-transitory computer readable storage medium according to claim 18, wherein the machine translation model further comprises an encoder and a decoder; and
inputting the intervention text to the pretrained machine translation model, and outputting the first translation result of the intervention text, comprises:
encoding the other text part in the intervention text by the encoder to obtain a vector sequence corresponding to the other text part; and
decoding the vector sequence by the decoder to obtain the translation result of the other text part.

20. The non-transitory computer readable storage medium according to claim 19, wherein encoding the other text part in the intervention text by the encoder to obtain the vector sequence corresponding to the other text part, comprises:
performing word segmentation on the other text part in the intervention text by the encoder to obtain a word segmentation result;
generating feature vectors corresponding to words in the word segmentation result; and
generating the vector sequence corresponding to the other text part based on the feature vectors corresponding to the words in the word segmentation result.
